(19) United States
(12) Patent Application Publication
(10) Pub. No.: US 2019/0122121 A1
(43) Pub. Date: Apr. 25, 2019

(54) METHOD AND SYSTEM FOR GENERATING INDIVIDUAL MICRODATA

(71) Applicant: AISA Innotech Inc., Taipei City (TW)

(72) Inventor: YUNG-KANG YU, Taipei City (TW)

(73) Assignee: AISA Innotech Inc., Taipei City (TW)

(21) Appl. No.: 16/162,378

(22) Filed: Oct. 16, 2018

Related U.S. Application Data
(60) Provisional application No. 62/576,050, filed on Oct. 23, 2017.

(51) Int. Cl. G06N 3/12; G06T 1/20; A63F 13/60

(52) U.S. Cl. CPC G06N 3/126; A63F 2300/60; A63F 13/60; G06T 1/20

(57) ABSTRACT

A method and system for generating individual microdata which has a device having an AI algorithm which is a gaming engine of instant rendering computing capability having a logical frame of at least 5 fps (5 frames per second). The method and system can be self-learning, judging and actively interacting with the user, i.e. interacting with the user and continually evolving to learn the user's preference habits, thereby obtaining microdata, and changing the interaction mode according to the microdata, or changing the questions submitted and/or selected.

The present application claims priority to U.S. Provisional Appl. No. 62/576,050, filed Oct. 23, 2017 which is incorporated herein by reference in its entirety.

### FIELD OF THE INVENTION

The present invention relates to a method and system for generating individual microdata, in particular to them of a self-learning, judging, and actively interacting with a user, interacting with the user autonomously, continuously evolving the user's preference habits, obtaining microdata and then changing the interaction mode or the questions and selectors based on these microdata.

DESCRIPTION OF RELATED ART

In the conventional artificial intelligence (AI), “Data” used for analysis, calculation, and learning is defined as “Big Data”, which collects a large amount of individual data through extensiveness. After that, the learning is performed by the artificial intelligence AI, and the data acquisition methods are mainly the following two types: (1) Search Information (SI): Let AI “search” information on the Internet or in a specific database. The information obtained in this way is the information that already exists. This includes past examples of specific technologies, behavioral habits for specific individuals, and other information such as “Go Chess” and “Personal Purchase Records”. (2) Record Information (RI): To install a program module that can record information on hardware objects such as industrial equipment or personal use devices, and records specific information when the device is in operation or when the device is used by the individuals. The information obtained by the method is information that does not exist before use, but will appear in the course of use, such as “equipment operation frequency”, “personal heartbeat record” and the like.

Existing big data, artificial intelligence AI will carry out analysis and deep learning mode for searching or recording information, then transmitting these data of big data to the cloud and using one to hundreds of supercomputers constructed in the cloud. The computer performs deep learning and analysis comparison with various algorithms. The purpose is to gradually strengthen the intelligence and accuracy of artificial intelligence AI for a specific purpose by calculating the amount of data. Various artificial intelligence AIs such as “Go Chess”, “Image Recognition”, “Face Recognition”, “Technical Operations”, and “Human Consumer Behavior Judgment”. However, the prior arts are mostly in the collection of a large amount of data, and it is impossible to comprehensively understand a single individual to collect big data, so it has many inconveniences.

### SUMMARY OF THE INVENTION

The main object of the present invention is to solve the conventional technical problems to provide a method of generating individual microdata comprising the steps of:
(a) providing a device with an artificial intelligence algorithm, using a central processing unit of the device, the artificial intelligence algorithm being writtenby a game engine with instant rendering computing capability of at least 5 fps (more than 5 frames per second);
(b) utilizing the central processing unit of the device to actively provide the individual with an interactive question or a different interaction mode, wherein the interactive question or the different interaction mode has at least ten preference parameter settings; and
(c) using the device to obtain microdata for the individual to be stored in the memory of the device as needed.

According to the method of the present invention, preferably the steps (a) to (c) are repeated to continuously evolve the learning of the artificial intelligence algorithm and to adjust different interaction questions or different interaction modes, thereby obtaining more microdata for the individual to be stored in the memory of the device as needed.

According to the method of the present invention, preferably the individual is a human.

In accordance with the method of the present invention, preferably the artificial intelligence algorithm has a logic frame of at least 60 fps.

In accordance with the method of the present invention, preferably a topic of the interactive question is selected to be at least fifty questions.

In accordance with the method of the present invention, preferably the artificial intelligence algorithm interacts with the individual, and the selection and order of the questions may be different for each question.

According to the method of the present invention, preferably the interaction question or the different interaction mode has at least one hundred and forty-four preference parameter settings.

According to the method of the present invention, preferably the method is for a product or application related to a human preference habit.

According to the method of the present invention, the human preference habit related product is an application personal advertisement recommendation system, an artificial intelligence assistant, a smart home, a robot or a smart car.

Another object of the present invention is to provide a system for generating individual microdata comprising:
(a) a cloud service layer device which operates in the same mode as existing big data artificial intelligence, and which uses a server to analyze and compare large amounts of data in the cloud for deep learning;
(b) an internet network electrically connected to the cloud service layer device; and
(c) a user-side device electrically connected to the internet network, the user-side device comprising a central processing unit executing an artificial intelligence algorithm on the central processing unit, utilizing the user-side device the central processing unit being not required to be connected to the network and can independently learn, judge and can actively interact with the user, can interact with the user and can evolve the learning preferences of the user, can obtain microdata, and then can change the interaction mode or the questions raised according to the microdata, alternatively, the user-side device being an edge computing, and comprising a computing module, the artificial intelligence algorithm being written by a game engine with a logic frame of at least 5 fps (more than 5 frames per second) of instant rendering computing capability.

According to the system of the present invention, preferably the artificial intelligence algorithm uses the central processing unit of the user-side device to perform “active interaction”, “microdata collection”, and “user-side learning” for the individual, “record and upload individual preference microdata information”, “change your own mode or question content” and/or “repetitive interaction” and other processes.

According to the system of the present invention, preferably the artificial intelligence algorithm comprises the steps of: using a central processing unit of the user-side device to perform SEO optimization, user importing, and obtaining microdata; depending on the situation, carrying out superposition analysis or micro data analysis; if the superposition analysis being performed, the physical site data comparison being performed, or if the microdata analysis being performed, the recommendation being derived; if the physical site data comparison being performed, the deep learning or marketing mode comparison being performed; if recommendation being derived, deep learning being performed; if marketing mode comparison being performed, deep learning being performed; if deep learning being performed, algorithm adjustment being performed; if algorithm adjustment being performed, microdata analysis or cross-domain main consciousness library being performed; if the cross-domain main consciousness library being performed, the network main information content enhancement being performed; and if the network main information content enhancement being performed, it returning to SEO optimization.

According to the system of the present invention, preferably the computing module comprises: an active question chatbot module, an all-round health management module, an intelligent financial advisor module, a life information link module, personalized emotion creation module and assistant module for the whole field diversion platform using a central processing unit of the device.

According to the system of the present invention, preferably the system further comprises a memory.

According to the system of the present invention, preferably the computing module further comprises a blockchain software module.

Another object of the present invention is to provide a system for generating individual microdata comprising:
(a) a cloud service layer device which operates in the same mode as existing big data artificial intelligence, and uses a server to analyze and compare large amounts of data in the cloud for deep learning;
(b) an internet network that is electrically connected to the cloud service layer device;
(c) a fog node electrically connected to the internet network; and
(d) a user-side device electrically connected to the fog node, the user-side device comprising a central processing unit, an artificial intelligence algorithm being executed on the fog node, and the fog node needing to be connected to the network to conduct learning, judgment and active interaction with users, and to actively interact with users and to evolve the learning preferences of users, to obtain microdata, and then to change their own interaction modes or questions and choices based on these microdata, the user-side device being a fog computing, which comprises a computing module, which is written by a game engine with logic frame of at least 5 fps (more than 5 frames per second) of instant rendering computing capability.

According to the system of the present invention, preferably the system further comprises an IoT (internet of things) platform equipment electrically connected to various sensors in a smart city or smart home.

Another object of the present invention is to provide a system for generating individual microdata comprising:
(a) a cloud service layer device which operates in the same mode as existing big data artificial intelligence, and uses a server to analyze and compare large amounts of data in the cloud for deep learning;
(b) an internet network that is electrically connected to the cloud service layer device; and
(c) a user-side device electrically connected to the internet network, the user-side device comprising a central processing unit executing an artificial intelligence algorithm on the cloud service layer device, wherein the cloud service layer device is required to be connected to the network to independently learn, judge and actively interact with the user, to interact with the user and to evolve the learning preferences of the user, to obtain microdata, and then to change the interaction modes or the questions and choices based on the microdata, the user-side device is a cloud computing, and comprises a computing module, an artificial intelligence algorithm is written by a game engine with logic frame of at least 5 fps (more than 5 frames per second) of instant rendering computing capability.

### BRIEF DESCRIPTION OF THE DRAWINGS

FIG. 1 is a circuit diagram of a system for generating individual microdata according to first to third embodiments of the present invention.

FIG. 2 is a circuit block diagram of a system for generating individual microdata according to first to third embodiments of the present invention.

FIG. 3 is a flowchart of an artificial intelligence algorithm engine of the first to third embodiments of the present invention.

FIG. 4 is a schematic diagram of a decision tree of the artificial intelligence algorithm of the first to the third embodiments of the present invention.

### DETAILED DESCRIPTION OF THE PREFERRED

### Embodiment

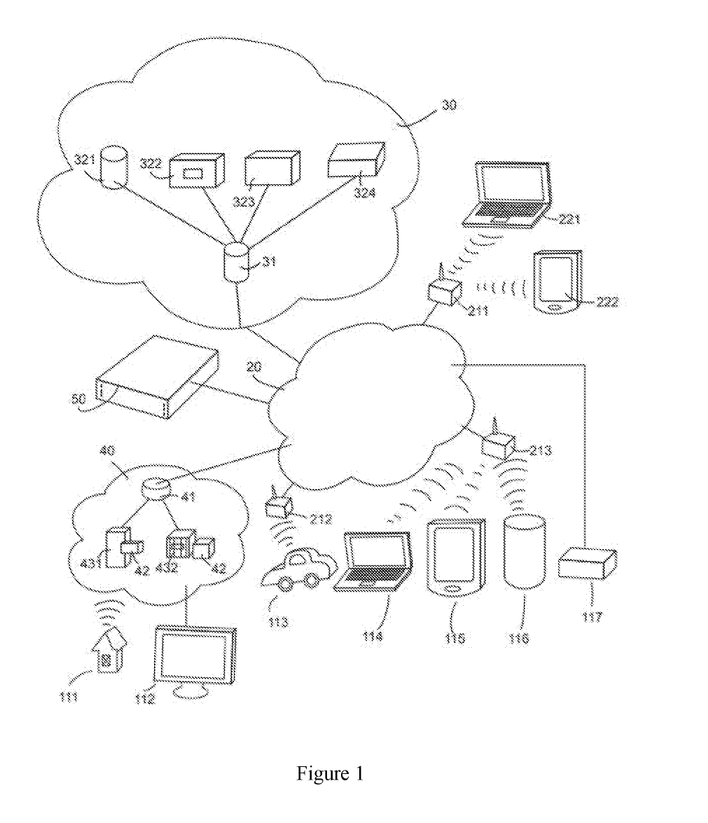

Referring to FIG. 1 to FIG. 4, in accordance with a first embodiment of the present invention, an edge computing is taken as an example, and the present invention provides an artificial intelligence (AI) designed to acquire personal “micro data”. The algorithm of AI is written by a game engine with at least 16 fps (more than 16 frames per second). The artificial intelligence AI using this algorithm will actively ask questions or interact with the user in various modes, and through the multi-layer architecture of the neural network and using at least ten kinds of preference parameter settings, the user can obtain the “microdata (Microdata)”. Through the repetitive computation of this process, the artificial intelligence AI using this algorithm will continue to evolve and learn, adjust its own interaction mode or raise questions, thereby gaining more “microdata” for users and deeper understanding the preference habits of the users.

Referring to FIG. 1, according to a first embodiment of the present invention, an edge computing operation is taken as an example, and the present invention uses a processing mode completely different from existing big data and artificial intelligence (AI), the purpose of which is “targeting a single individual has a comprehensive and in-depth understanding”, rather than “general collection of large amounts of individual data”. The information collection method of the present invention is different from the above-mentioned “search information (SI)” and “record information (RI)” of the existing information collection methods, but a newly defined “created information” mode as described as follows:

Referring to FIG. 1, according to a first embodiment of the present invention, an edge computing operation is taken as an example, and a creation information (CI) is generated by an artificial intelligence AI via a “active questioning” or “actively giving a choice”. A variety of modes, such as “dialogue”, “game”, “psychological test”, etc., of interacting with the user to obtain a large amount of data for the single user during the user interaction process (this data are referred to as “Microdata” in the definition of the present invention). The information obtained in this way is “it did not exist in the past in the Internet or any database”, and they do not appear, but the information that will appear in the process after the human intelligence AI actively interacts with the user. Because this information can be “created” by actively interacting with individuals through artificial intelligence AI, this information acquisition method is defined as “created information.”

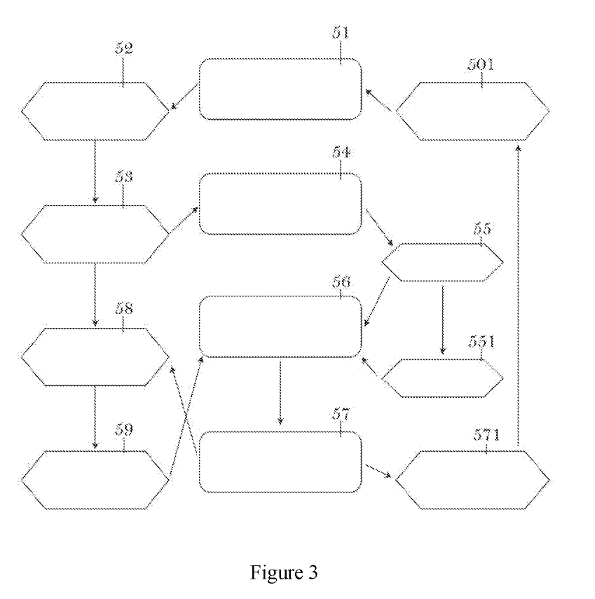

The artificial intelligence algorithm engine of the first embodiment to the third embodiment of the present invention refers to FIG. 3, first, the algorithm proceeds to SEO optimization 51, and then the user imports 52, and the microdata obtains 53; according to the situation, the superposition analysis 54 or the microdata analysis 58 may be performed; if the superposition analysis 54 is performed, the physical site data comparison 55 is performed, or if the microdata analysis 58 is performed, the recommendation derivation 59 is performed; after the physical site data comparison 55, the deep learning 56 or the marketing mode comparison 551 is performed; if the recommendation derivation 59 is performed, the deep learning 56 is performed; if the marketing mode comparison 551 is performed, the deep learning 56 is performed; after the deep learning 56, the algorithm adjustment 57 is performed; if the algorithm adjustment 57 is performed, the microdata analysis 58 is performed or the cross-domain main consciousness library 571 is performed; if the cross-domain main consciousness library 571 is performed, the information main content enhancement 501 is performed; the information main content enhancement 501 is performed; if the network subject information content is enhanced 501, it returns to SEO optimization 51.

Referring to FIG. 1, according to a first embodiment of the present invention, an edge computing operation is taken as an example, and the artificial intelligence AI algorithm of the present invention is a “dual-main-core algorithm”, and the algorithm calculation is divided into two parts: a “cloud server main core” and a “user-side main core.” The “cloud server main core” operates in the same way as the existing Big Data Artificial Intelligence AI computing. In the cloud, it uses a supercomputer to analyze and compare large amounts of data for deep learning. However, its information source is different from the existing big data artificial intelligence AI. It is the information created by the “user-side main core.” After the user connects it to the network, it performs calculations on the “user-side main core” and then uploads data to the “cloud server main core” and it perform other operations.

Referring to FIG. 1, according to a first embodiment the present invention, an edge computing operation is taken as an example, and a “user-side main core” is a core mode of an algorithm of the present invention, and is used for information computing and learning equipment, and the software is completely different from the existing artificial intelligence AI module, as detailed below:

(1A) Device: The hardware device used by the “user-side main core” is different from the cloud computing host of the existing big data artificial intelligence AI, and is an “edge computing device.” This “user-side main core” can operate independently on a personal device. It can also learn, judge and actively interact with users without “connecting to the Internet.” That is to say, the “user-side main core” itself is an AI artificial intelligence, which can interact with the user autonomously and continuously evolve to learn the user's preference habits, to obtain microdata, and then to change the interaction mode or to propose questions and choices according to the microdata. Referring to FIG. 1, according to a third embodiment of the present invention, an edge computing operation is taken as an example, and the device (such as the car 113, the personal computer/notebook 114, the smart phone 115, the smart speaker 116, and the gateway 117) is electrically connected to the Internet 20 by using the WiFi router 213 or the router 212, and is electrically connected to the cloud service layer 30 through the gateway/router 31. The cloud service layer 30 comprises a conversation chatbot server 321, a video server 322, a calculation server 323, and a control server 324, etc. Other users can connect to the Internet 20 via the WiFi router 211 using the personal computer/laptop 221 or the smart phone 222.

(2A) Algorithm Engine: The algorithm writing engine used by the “user-side main core” is not a model algorithm engine provided by other artificial intelligence AIs, such as TensorFlow, nor is it written by a specific system of the algorithm language. Instead, it uses the built-in computer language (such as C#) or a plug-in support for the game development engine with instant rendering capabilities, such as the game development engine Unity. The specific requirement of this algorithm is that the logic frame is at least 5 fps, 16 fps is better, and the best effect is above 60 fps. Logic frame is defined as settings of the screen update rate per second for the game development engine of the instant rendering, that is, the amount of frames per second. For example, if the fps is 60, the amount of frames and the amount of logical operations per second that can be displayed per second using this algorithm's App or web program are 60.

(3A) Algorithm Content: The content of the algorithm of the present invention is an AI artificial intelligence running for a “specific single entity”, including “active interaction”, “microdata collection”, and “user-side learning”, “record and upload individual preference microdata information”, “change your own mode or question content”, “repetitive interaction” and other processes. This algorithm has several special requirements as follows:
(a) The choice of interactive topics in a single field is at least 10 questions, 20 questions are better, and 50 questions or more may have the best effect. Depending on the operation process of different individuals, the choice and order of questions for AI questions will be different.
(b) This algorithm adds the property of “Bayes' theorem.” Even if it interacts with the same individual, the choice and order of questions for each question may be different.
(c) This algorithm can interact in the composite field, and has at least two, five better, and more than twelve interactive modules with the best effects, which can be used to change the interactive mode selection by artificial intelligence AI.
(d) This algorithm has at least ten or more, at least twelve or more, thirty-six better, and one hundred and forty-four preferred preference categories and parameter values for “personal preferences”.
(e) This algorithm can record, calculate, upload the user's microdata in the interactive process, and learn independently on the user side. According to the effect of the learning process, the operation mode, parameters and question selection are changed, that is, after a preliminary understanding of a single individual, change the interaction method and content, form a cycle, and deepen understanding again, so that the cycle can be repeated at least five times, twelve times better, thirty times or more. The most detailed and comprehensive understanding of the individual can be achieved.

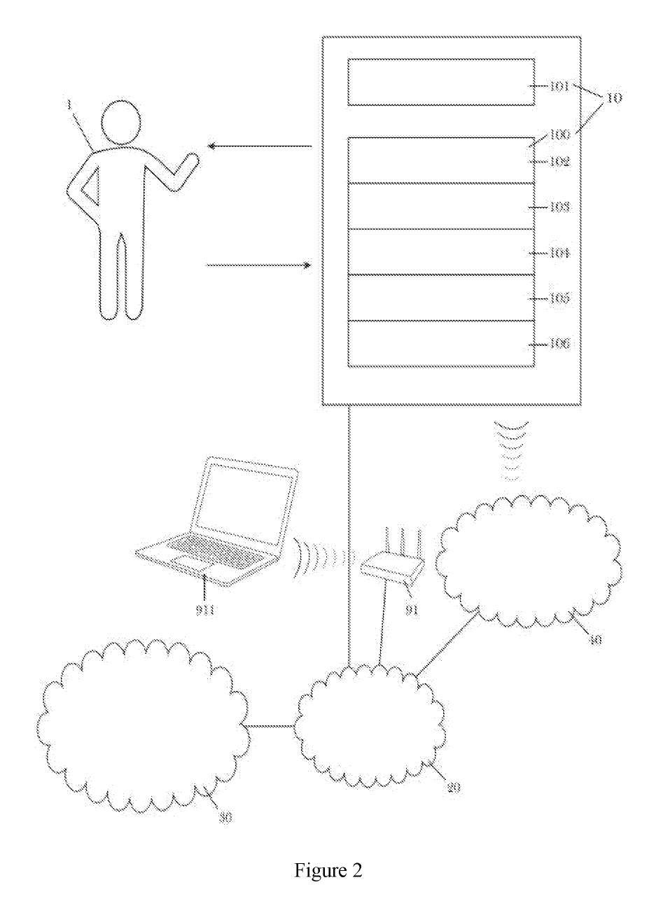

(4A) According to a first embodiment of the present invention, an edge computing operation is taken as an example, and a circuit block diagram is shown in FIG. 2, and the device 10 may be a personal computer, a notebook computer, a smart phone, a tablet computer, or the like. The AI software is installed and run on the central processing unit 10, and the AI software comprises an computing module 100, comprising an active question chatbot module 101, an all-round health management module 102, an intelligent financial advisor module 103, a life information link module 104, a personalized emotion creation module 105, an assistant module for full field diversion platform 106, and the like. The user 1 is actively asked by the device 10 or the device 10 provides different interaction modes and/or preference parameter settings of the user 1 to enable the device 10 to obtain the user's microdata. The device 10 is electrically connected to the Internet 20 and then electrically connected to the cloud service layer 30 for connection to the second user's laptop 911 via a WiFi router 91.

According to the first embodiment of the present invention, the active question chatbot module 101 uses a chatbot, such as an audio/text expression, to obtain microdata and preferences and other information from the device's active conversation query.

According to the first embodiment of the present invention, the all-round health management module 102 can be connected to a personal artificial intelligence medical health management system of a hospital, and comprises an active care sub-module, a smart diet recommendation sub-module, a living habit improvement sub-modules, leisure sports management sub-modules, etc. The active care sub-module has the functions of self-care and questioning based on the physical and mental condition of the user, and continuous interactive learning. The smart diet recommendation sub-module has the effect of recommending the most appropriate combination among a plurality of ingredients according to the user's preference. The living habit improvement sub-module has the effect of regulating from the subtleties of life, thereby improving health and preventing diseases. The leisure sports management sub-module has the functions of leisure and sports, intelligent management assistance, and the creation of the highest health benefits.

According to the first embodiment of the present invention, the intelligent financial advisor module 103 can help the user to use artificial intelligence to invest in financial management, such as stock market, futures, foreign currency, fund operation recommendations, and the like. The intelligent financial advisor module 103 comprises a portfolio recommendation sub-module, a wealth management knowledge learning sub-module, a consumer discount providing sub-module, and a personal wealth management sub-module. The portfolio recommendation sub-module has the effect of recommending the best investment portfolio based on personal preference characteristics. The wealth management knowledge learning sub-module has the functions of giving multi-financial knowledge according to personal conditions and enriching personal abilities. The consumer discount providing sub-module has, for example, a connection to various fields of e-commerce and entity merchants to provide various consumer benefits and feedback. The personal wealth management sub-module, such as a small helper with life finance, can provide billing assistance and wealth planning.

According to a first embodiment of the present invention, examples of the life information link module 104 are a coffee shop chatbot, a soy milk king store chatbot, a convenience store chatbot, a homestay web store chatbot, a clothing store website chatbot, a steak shop chatbot, etc.

According to the first embodiment of the present invention, the personalized emotion creation module 105 comprises an independent personality system sub-module, an autonomous learning evolution sub-module, a deep emotion connection sub-module, an emotional care sub-module, an interest sharing sub-module, a life knowledge sub-module, a game interaction sub-module, a community communication sub-module, etc.

According to a first embodiment of the present invention, the assistant module for full field diversion platform 106 is a virtual full-area diversion platform assistant for all areas of the special economic zone, including a healthy diet building, a collection mall, an open market, a financial service building, a car life building, etc.

According to the first embodiment to the third embodiment of the present invention, the artificial intelligence algorithm of the present invention adopts multi-layer computing, and the multi-layer computing is that the last output option is the next input option, that is, the input and output bidirectional multi-level computing algorithm. The big data of the traditional method is to classify a large amount of data into trees. Through the algorithm, the “input information” on the decision tree map is closest to the “output layer” result in the database, and the error is calculated to let the error rate close to zero so as to obtain the comparing results. This is also the principle of visual image processing and recognition. The traditional scoring system will continue to increase the weight according to the path of the user through the decision tree. Each comparison is very similar. But the traditional method is completely inconsistent with human nature. For example, every time a smart voice assistant comes up with the suggestion that you eat a hamburger, do you want to eat hamburgers every day? The algorithm of the present invention records the path of the decision tree diagram, but each time it repeats the calculation, and finds other possible probabilities outside the path of the decision tree diagram, and throws information to the user to make a choice of the calculation path. The present invention creates information such as microdata, because people understand people through communication, and the traditional method of obtaining information is one-way device-to-person communication, and the present invention is to create microdata by device-to-person. For people's information, to carry out device-to-person two-way communication, and to grasp the user's human characteristics in the process of device-to-person communication (for example, enthusiasm, turtle, chicken, perfect, fair, stubborn, conservative, etc.), the answers to user for getting each individual characteristic will change the calculation path of the decision tree diagram, or change the communication mode of the device-to-person to generate a new answer (for example, after answering a question, the answer is to watch the Korean drama, and the speculation is that the food is fried chicken with beer). This is the adaptive algorithm of the present invention. The device is used to interact with humans to create personalized microdata, and the algorithm of the present invention is used to judge the user's next thinking or decision.

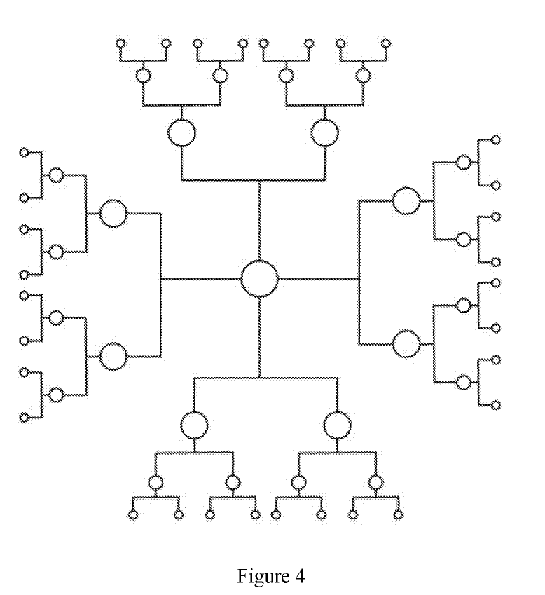

According to the first embodiment to the third embodiment of the present invention, the artificial intelligence algorithm of the present invention adopts a multi-layered algorithm system using a neural network of a decision tree diagram, which is from the starting point toward four directions, that is, up, down, left, and right with the directions extending as shown in FIG. 4.

Referring to FIG. 1, (1B) According to a second embodiment of the present invention, an apparatus is exemplified by a fog computing with a fog node and an artificial intelligence Internet of Things (AIoT). The device (such as the smart city 111 and the smart home 112 shown in FIG. 1) is electrically connected to the Internet 20 through the router 41 through the 4G communication 431 and the fiber-to-the-home 432 in the fog node 40, and is electrically connected to the cloud service layer 30 through the gateway/router 31. The cloud service layer 30 comprises a conversation chatbot server 321, a video server 322, a calculation server 323, a control server 324, and the like. In addition, an Internet of Things platform device 50 is electrically connected to various sensors in the smart city 111 and the smart home 112 (for example, a temperature sensor, a humidity sensor, a flow rate sensor, an acceleration sensor, a chemical substance sensor, etc.).

(2B) According to a second embodiment of the present invention, the algorithm engine: The algorithm for writing the algorithm used by the “user-side main core” is not the model algorithm engine provided by other AIs, such as TensorFlow, and it is also not written by the algorithmic language of a particular system. It is not necessarily built using the built-in language (such as C#) or plug-in support for “game development engine with instant rendering computing power.”

(3B) According to a second embodiment of the present invention, the content of the algorithm: the content of the algorithm of the present invention is an AI artificial intelligence running for a “specific single individual”, including “active interaction”, “microdata collecting”, “user-side learning”, “recording and uploading individual preference microdata information”, “changing your own mode or questioning content”, “repetitive interaction” and other processes. The algorithm of the present invention is mainly performed on the fog node 40.

(4B) According to a second embodiment of the present invention, a fog node is taken as an example, and a circuit block diagram is shown in FIG. 2, and the device 10 can be a personal computer, a notebook computer, a smart phone, a tablet computer, etc. The difference between the two figures is that the algorithm software is installed on the fog node 40. The algorithm software comprises a computing module 100, including an active question chatbot module 101, an all-round health management module 102, an intelligent financial advisor module 103, a life information link module 104, a personalized emotion creation module 105, an assistant module for the whole field diversion platform 106, and the like. The user 1 is actively asked by the device 10 or provides different interaction modes and/or preference parameter settings of the user 1 to enable the device 10 to obtain the user's microdata. The device 10 is electrically connected to the fog node 40, to the Internet 20, and then to the cloud service layer 30 for connecting to the second user's laptop 911 via a WiFi router 91.

Please refer to FIG. 1. (1C) According to a third embodiment of the present invention, a device: a hardware device used by a “cloud server main core” is equivalent to a cloud host of an existing big data AI. The “user-side main core” can operate independently on a personal device. It can also learn, judge and actively interact with users without “connecting to the Internet”. That is to say, the “user-side main core” itself is an AI artificial intelligence data processing terminal, which can interact with the user autonomously and continuously evolve to learn the user's preference habits, to obtain microdata, and then to change the interaction mode or to ask questions and choices according to the microdata. Referring to FIG. 1, according to a third embodiment of the present invention, a cloud computing operation is taken as an example, a device (such as the automobile 113, the personal computer/notebook 115, the smart phone 115, the smart speaker 116, the gateway 117, and the like) is electrically connected to the Internet 20 by using the WiFi router 213 or the router 212, and is electrically connected to the cloud service layer 30 through the gateway/router 31. The cloud service layer 30 comprises a conversation chatbot server 321, a video server 322, a calculation server 323, a control server 324, etc. Other users can connect to the Internet 20 via the WiFi router 211 using the personal computer/laptop 221 or the smart phone 222.

(2C) According to a third embodiment of the present invention, the algorithm engine: the algorithm-writing engine used by the “user-side main core”, is not a model algorithm module engine provided by other AIs, such as TensorFlow. It is also not written by the algorithmic language of a specific system. Instead, it uses the built-in language (such as C#) or plug-in support for the “game development engine with instant rendering capabilities”.

(3C) According to a third embodiment of the present invention, the content of the algorithm: the content of the algorithm of the present invention is an AI artificial intelligence running for a “specific single entity”, including “active interaction” and “microdata collecting”, “user-side learning”, “recording and uploading individual preference microdata information”, “changing your own mode or questioning content”, “repetitive interaction” and other processes. The third embodiment of the present invention is performed primarily on the cloud services layer 30.

(4C) According to a third embodiment of the present invention, a cloud computing operation is taken as an example, a circuit block diagram is shown in FIG. 2, and the device 10 can be a personal computer, a notebook computer, a smart phone, a tablet computer, etc. The difference between the two diagrams is that the algorithm software is installed on the cloud service layer 30. The algorithm software comprises a computing module 100, including an active question chatbot module 101, an all-round health management module 102, an intelligent financial advisor module 103, a life information link module 104, a personalized emotion creation module 105, an assistant module for the whole field diversion platform 106, and the like. The user 1 is actively asked by the device 10 or provides different interaction modes and/or preference parameter settings of the user 1 to enable the device 10 to obtain the user's microdata. The device 10 is electrically connected to the Internet 20 and then electrically connected to the cloud service layer 30 for connecting to the second user's laptop 911 via a WiFi router 91.

Therefore, the invention of the microdata algorithm can be applied to various levels, and since the purpose is “the understanding of human individual preference habits”, products or applications related to human preference habits can be linked. Examples are as follows:
(1) Personal advertisement recommendation system: After understanding the individual preferences through the microdata algorithm, recommending the most suitable product or advertising information to a single individual can achieve a higher success rate than the general advertisement recommendation system.
(2) Artificial Intelligence Assistant: Using the microdata algorithm to create an artificial intelligence assistant, you can understand the user's preference habits more accurately, and have the ability to “actively ask questions and interact”. The chatbot that the database search answers has more development possibilities and is more humane.
(3) Smart home: By applying the microdata algorithm to the smart home management system, we can better understand the various needs and usage habits of the smart home, so that smart home is not just an “automated process” but can have the artificial intelligence AI core that truly understands the user's emotional state, and responds to changes based on this, such as changing home lighting, music, and so on.
(4) Robot: The robot created by the microdata algorithm artificial intelligence AI will be able to actively interact with humans and deeply understand, record the individual preference characteristics and personality of the interacting objects. To become a robot is equivalent to the real social friendship of the average person.
(5) Smart car: Applying microdata algorithm Artificial intelligence AI in the main database of smart car, can record the user's operating habits, reaction speed, etc., and assist with artificial intelligence AI for different road conditions or emergency events with handling to improve driving safety and stability.

The above is only an example application. The microdata algorithm can be applied to a variety of application modules, or a new product can be developed by itself, because it has the characteristics of “actively understanding the comprehensive preferences of a single individual”, so it can be widely used. Used at all levels of business or to enhance the convenience of human life.

### WORKING EXAMPLES

As shown in FIG. 2, the artificial intelligence AI algorithm of the present invention interacts with the user, and judges the user's participation and interest according to the interaction situation. If the interactive interest is not high, the artificial intelligence AI algorithm will change the module, the module comprises a small game or chat, and the module can comprises many types, such as pictures, texts or situation simulations, so that the artificial intelligence AI algorithm can use the modules to observe the user's preferences in order to change their own response methods. As shown in FIG. 3, the artificial intelligence AI algorithm, through the flowchart of FIG. 3, continues to operate in a loop, will continue to learn to grow, change itself, to achieve more and more understanding of the user's effect, and to become more accurate and efficient interact with the user.

As shown in FIG. 1, the technology of the artificial intelligence Internet of Things (AIoT) using the Internet of Things platform device 50 of the present invention comprises at least three major fields, one is a voice assistant, the other is a voice service system in various languages, and the third is home robots, which are applied to various computer platforms, smart appliances, security monitoring, mobile applications, and autonomous vehicles. It further includes smart business, drone delivery, unmanned taxis, unmanned stores, face recognition payments, smart dining tables, smart billboards, smart shelves, emotional social robots, commercial navigation robots, logistics robots and more.

As shown in FIG. 1, the technology of the AIoT of the Internet of Things platform device 50 of the present invention further extends to the smart life service platform, just like a domestic servant.

The technology of the artificial intelligence Internet of Things (AIoT) of the present invention is further combined with a blockchain software module, which has a blockchain 1.0 (bitcoin: starting from a decentralized book) technology, zone Blockchain 2.0 (Ethernet: Smart Contract Certification) Technology, Blockchain 3.0 (IOTA: Connected to physical life, artificial intelligence Internet of Things, micropayments).

The category of the artificial intelligence AI algorithm of the present invention includes a classification of a preference parameter, a preference link parameter, a time coefficient, and a personal personalized value, wherein the individual personalized value includes an individual's rational value, emotional value, risk tolerance, More than five types of values such as taste and specialty.

What is claimed is:

1. A method of generating individual microdata comprising the steps of:
(a) providing a device with an artificial intelligence algorithm, using a central processing unit of the device, the artificial intelligence algorithm being written by a game engine with instant rendering computing capability of at least 5 fps (more than 5 frames per second);
(b) utilizing the central processing unit of the device to actively provide the individual with an interactive question or a different interaction mode, wherein the interactive question or the different interaction mode has at least ten preference parameter settings; and
(c) using the device to obtain microdata for the individual to be stored in the memory of the device as needed.

2. The method as claimed in claim 1, wherein the steps (a) to (c) are repeated to continuously evolve the learning of the artificial intelligence algorithm and to adjust different interaction questions or different interaction modes, thereby obtaining more microdata for the individual to be stored in the memory of the device as needed.

3. The method as claimed in claim 1, wherein the individual is a human.

4. The method as claimed in claim 1, wherein the artificial intelligence algorithm being written by a game engine with instant rendering computing capability of at least 60 fps.

5. The method as claimed in claim 1, wherein a topic of the interactive question is selected to be at least fifty questions.

6. The method as claimed in claim 1, wherein the artificial intelligence algorithm interacts with the individual, and the selection and order of the questions may be different for each question.

7. The method as claimed in claim 1, wherein the interaction question or the different interaction mode has at least one hundred and forty-four preference parameter settings.

8. The method as claimed in claim 1, wherein the method is for a product or application related to a human preference habit.

9. The method as claimed in claim 8, wherein the human preference habit related product is an application personal advertisement recommendation system, an artificial intelligence assistant, a smart home, a robot or a smart car.

10. A system for generating individual microdata comprising:
(a) a cloud service layer device which operates in the same mode as existing big data artificial intelligence, and which uses a server to analyze and compare large amounts of data in the cloud for deep learning;
(b) an internet network electrically connected to the cloud service layer device; and
(c) a user-side device electrically connected to the internet network, the user-side device comprising a central processing unit executing an artificial intelligence algorithm on the central processing unit, utilizing the user-side device the central processing unit being not required to be connected to the network and can independently learn, judge and can actively interact with the user, can interact with the user and can evolve the learning preferences of the user, can obtain microdata, and then can change the interaction mode or the questions raised according to the microdata, alternatively, the user-side device being an edge computing, and comprising a computing module, the artificial intelligence algorithm being written by a game engine with a logic frame of at least 5 fps (more than 5 frames per second) of instant rendering computing capability.

11. The system as claimed in claim 10, wherein the artificial intelligence algorithm uses the central processing unit of the user-side device to perform “active interaction”, “microdata collection”, and “user-side learning” for the individual, “record and upload individual preference microdata information”, “change your own mode or question content” and/or “repetitive interaction” and other processes.

12. The system as claimed in claim 10, wherein the artificial intelligence algorithm comprises the steps of: using a central processing unit of the user-side device to perform SEO optimization, user importing, and obtaining microdata; depending on the situation, carrying out superposition analysis or micro data analysis; if the superposition analysis being performed, the physical site data comparison being performed, or if the microdata analysis being performed, the recommendation being derived; if the physical site data comparison being performed, the deep learning or marketing mode comparison being performed; if recommendation being derived, deep learning being performed; if marketing mode comparison being performed, deep learning being performed; if deep learning being performed, algorithm adjustment being performed; if algorithm adjustment being performed, microdata analysis or cross-domain main consciousness library being performed; if the cross-domain main consciousness library being performed, the network main information content enhancement being performed; and if the network main information content enhancement being performed, it returning to SEO optimization.

13. The system as claimed in claim 10, wherein the computing module comprises: an active question chatbot module, an all-round health management module, an intelligent financial advisor module, a life information link module, personalized emotion creation module and assistant module for the whole field diversion platform using a central processing unit of the device.

14. The system as claimed in claim 10, further comprising a memory.

15. The system as claimed in claim 10, wherein the computing module further comprises a blockchain software module.

16. A system for generating individual microdata comprising:
(a) a cloud service layer device which operates in the same mode as existing big data artificial intelligence, and uses a server to analyze and compare large amounts of data in the cloud for deep learning;
(b) an internet network that is electrically connected to the cloud service layer device;
(c) a fog node electrically connected to the internet network; and
(d) a user-side device electrically connected to the fog node, the user-side device comprising a central processing unit, an artificial intelligence algorithm being executed on the fog node, and the fog node needing to be connected to the network to conduct learning, judgment and active interaction with users, and to actively interact with users and to evolve the learning preferences of users, to obtain microdata, and then to change their own interaction modes or questions and choices based on these microdata, the user-side device being a fog computing, which comprises a computing module, which is written by a game engine with logic frame of at least 5 fps (more than 5 frames per second) of instant rendering computing capability.

17. The system as claimed in claim 16, further comprising an IoT (internet of things) platform equipment electrically connected to various sensors in a smart city or smart home.

18. A system for generating individual microdata comprising:
(a) a cloud service layer device which operates in the same mode as existing big data artificial intelligence, and uses a server to analyze and compare large amounts of data in the cloud for deep learning;
(b) an internet network that is electrically connected to the cloud service layer device; and
(c) a user-side device electrically connected to the internet network, the user-side device comprising a central processing unit executing an artificial intelligence algorithm on the cloud service layer device, wherein the cloud service layer device is required to be connected to the network to independently learn, judge and actively interact with the user, to interact with the user and to evolve the learning preferences of the user, to obtain microdata, and then to change the interaction modes or the questions and choices based on the microdata, the user-side device is a cloud computing, and comprises a computing module, an artificial intelligence algorithm is written by a game engine with logic frame of at least 5 fps (more than 5 frames per second) of instant rendering computing capability.
